(19) United States
(12) Patent Application Publication
(10) Pub. No.: US 2018/0218631 A1
(43) Pub. Date: Aug. 2, 2018

(54) INTERACTIVE VEHICLE CONTROL SYSTEM

(71) Applicant: BAE Systems plc, London (GB)

(72) Inventors: Julian David Wright, Preston Lancanshire (GB); Nicholas Giacomo Robert Colosimo, Preston Lancanshire (GB); Christopher James Whiteford, Preston Lancanshire (GB)

(21) Appl. No.: 15/527,892

(22) PCT Filed: Nov. 11, 2015
(86) PCT No.: PCT/GB2015/053413

§ 371 Date: May 18, 2017

(30) Foreign Application Priority Data
Nov. 19, 2014 (GB) 1420570.2

(51) Int. Cl. G09B 9/30; G06T 19/00; G06F 3/01

(52) U.S. Cl. CPC G09B 9/307; G06F 3/011; G06T 19/006

(57) ABSTRACT

A mixed reality vehicle control system comprising a headset (100) including a screen (102), the system further comprising a processor (104) configured to display images representing virtual control elements (30) within a three dimensional virtual environment on said screen, wherein the system is configured to allow a user to interact with said virtual control elements (30) to control respective vehicle functions or operations, the system further comprising an image capture device for capturing images of the real world environment in the vicinity of the user within the user's field of view, including image data representative of physical control elements (70, 80) therein, and blend image data representative of at least portions of said user's field of view, including at least one of said physical control elements, into said three dimensional virtual environment to create a mixed reality vehicle control environment.

This invention relates generally to a method and apparatus for facilitating user control of the functions and/or operations of a vehicle.

Many vehicles, particularly but not necessarily exclusively, aircraft rely on highly specialised components in order to achieve either their normal their functionality or to perform a particular role. Military aircraft cockpits in particular may utilise very specialised components which have relatively low production quantities and relatively long lead times in terms of supply. Even the components utilised in commercial aircraft cockpits, which may comprise off-the-shelf units rather than bespoke components, are still highly specialised and have limited production quantities. As a result, the cost of change is high, and the ability to customise a cockpit design to customer requirements becomes difficult and costly. In addition, replacement items and long lead times can have a drastic effect on the availability of an aircraft, since such bespoke and disparate items can take a significant time to replace, during which use of the aircraft may be prevented.

A major limitation of such components in many platforms, but particularly aircraft, is their size, weight and power requirements, which parameters are already highly constrained in these environments.

It would, therefore, be desirable to provide a method and apparatus for controlling the functions and/or operations of a vehicle which at least addresses some of the problems outlined above.

Virtual reality systems are known, comprising a headset which, when placed over a user's eyes, creates and displays a three dimensional virtual environment in which a user feels immersed and with which a user can interact in a manner dependent on the application. For example, in some prior art systems, the virtual environment created may comprise a game zone, within which a user can play a game. However, in an environment where the user needs to be able to see where they are going in order to steer the vehicle, such systems are unsuitable.

More recently, augmented and mixed reality systems have been developed, wherein an image of a real world object can be captured, rendered and placed within a 3D virtual reality environment, such that it can be viewed and manipulated within that environment in the same way as virtual objects therein. Other so-called augmented reality systems exist, comprising a headset having a transparent or translucent visor which, when placed over a user's eyes, creates a three-dimensional virtual environment with which the user can interact, whilst still being able to view their real environment through the visor.

However, in an augmented reality environment, whereby the user can “see” all aspects of their real world environment through the visor as well as the multiple sources of data in the virtual environment, the resultant 3D environment becomes excessively cluttered and it becomes difficult for a user to focus on the important elements thereof.

It is therefore an object of aspects of the invention to address at least some of these issues.

In accordance with a first aspect of the present invention, there is provided a mixed reality vehicle control system for enabling monitoring and/or control within a vehicle of functions and/or operations thereof, the system comprising a headset including a screen, the system further comprising a processor configured to receive data from one or more sources within said vehicle and display images representing virtual control and/or display elements in respect of said vehicle, together with said data, within a three dimensional virtual environment on said screen, the system further comprising an image capture device for capturing images of the real world environment in the vicinity of the user within the user's field of view, including image data representative of physical control and/or display elements therein, and blend image data representative of at least portions of said user's field of view, including at least one of said physical control and/or display elements, into said three dimensional virtual environment to create a mixed reality vehicle control environment.

The system may be configured to allow said user, in use, to interact with and/or manipulate said virtual control elements, the processor being further configured to, in response to such user interaction or manipulation, transmit control data to respective vehicle functions or operations for control thereof,

The processor may be preconfigured to identify within said captured images at least one predefined physical control and/or display element in the real world within said vehicle, and blend image data representative thereof into said three dimensional virtual environment.

In an exemplary embodiment, the system may be configured to allow a user, in use, to manipulate data and/or interact with said virtual control elements by means of hand gestures; and may further comprise a physical control panel including one or more physical control devices which are manually actuatable by a user, wherein said processor is configured to identify, within said captured images, user hand gestures indicative of actuation of said one or more physical control devices and generate a respective control signal for controlling a function and/or operation of said vehicle.

In an exemplary embodiment, the system may comprise a pair of spatially separated image capture devices for capturing respective images of the real world environment in the user's field of view, said processor being configured to define a depth map using respective image frame pairs to produce three dimensional image data. The image capture devices may be mounted on said headset, and optionally so as to be substantially aligned with a user's eyes, in use.

The processor may be configured to generate information symbols or messages in relation to real world objects identified within said captured images, and blend image data representative thereof into said three dimensional virtual environment at an associated location therein.

Another aspect of the present invention extends to a method of providing a vehicle control station enabling monitoring and/or control within a vehicle of functions and/or operations thereof, the method comprising providing a mixed reality system as defined above, and configuring the processor to

receive data from one or more sources within said vehicle and display images representing virtual control and/or display elements in respect of said vehicle, together with said data, within a three dimensional virtual environment on said screen; and

blend image data representative of at least portions of said user's field of view, including at least one of said physical control and/or display elements, into said three dimensional virtual environment to create a mixed reality vehicle control environment.

The system may be configured to allow said user, in use, to interact with and/or manipulate said virtual control elements, and the method may include the step of configuring the processor to, in response to such user interaction or manipulation, transmit control data to respective vehicle functions or operations for control thereof,

In one exemplary embodiment of the invention, the vehicle control station may be an aircraft cockpit comprising a plurality of control elements.

The method may include the steps of providing a cockpit or vehicle cab structure including only a selected number of said control and/or display elements as physical control and/or display elements, providing the remaining control and/or display elements as virtual control and/or display elements within said three dimensional virtual environment, and configuring the processor to blend image data representative of a user's field of view, from said captured images, into said three dimensional virtual environment to create a mixed reality environment.

These and other aspects of the present invention will become apparent from the following specific description of exemplary embodiments of the present invention, which are described by way of examples only and with reference to the accompanying drawings, in which:

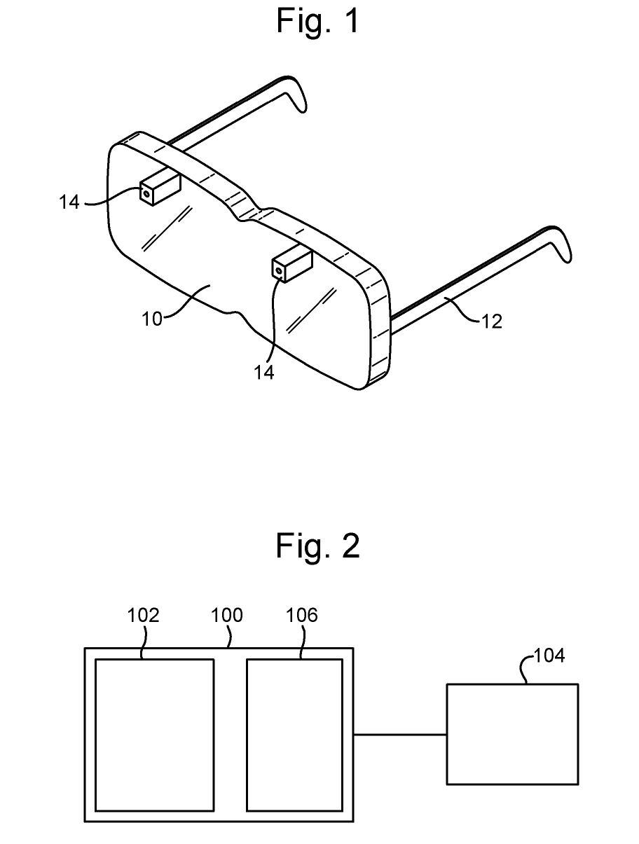

FIG. 1 is a front perspective view of a headset for use in a control system according to an exemplary embodiment of the present invention;

FIG. 2 is a schematic block diagram of a control system according to an exemplary embodiment of the present invention; and

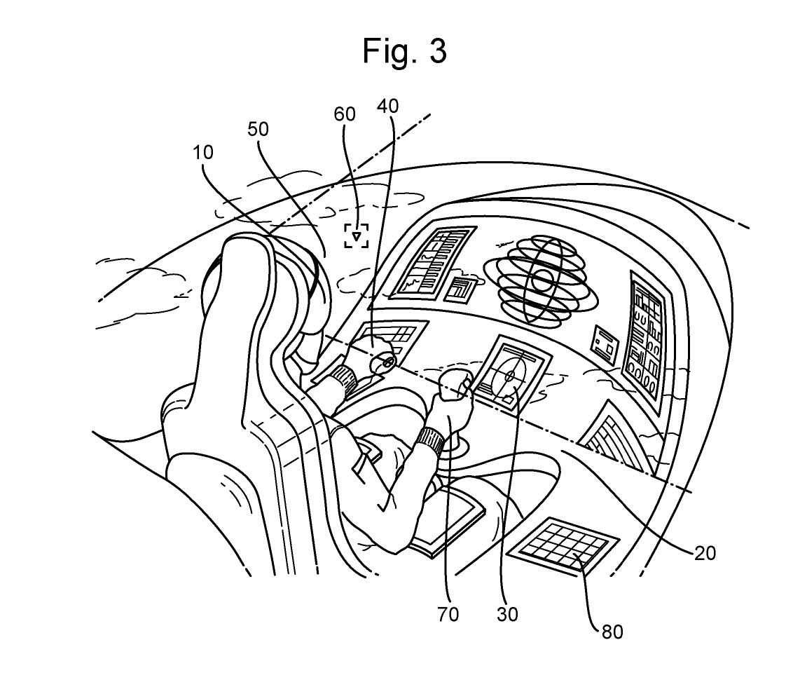

FIG. 3 is a schematic view of a mixed reality vehicle control environment created by a system according to an exemplary embodiment of the present invention.

Referring to FIG. 1 of the drawings, a system according to an exemplary embodiment of the present invention may comprise a headset comprising a visor 10 having a pair of arms 12 hingedly attached at opposing sides thereof in order to allow the visor to be secured onto a user's head, over their eyes, in use, by placing the curved ends of the arms 12 over and behind the user's ears, in a manner similar to conventional spectacles. It will be appreciated that, whilst the headset is illustrated herein in the form of a visor, it may alternatively comprise a helmet for placing over a user's head, or even a pair of contact lenses or the like, for placing within a user's eyes, and the present invention is not intended to be in any way limited in this regard. Also provided on the headset, is a pair of image capture devices 14 for capturing images of the environment, such image capture devices being mounted as closely as possible aligned with the user's eyes, in use.

The system of the present invention further comprises a processor, which is communicably connected in some way to a screen which is provided inside the visor 10. Such communicable connection may be a hard wired electrical connection, in which case the processor and associated circuitry will also be mounted on the headset. However, in an alternative exemplary embodiment, the processor may be configured to wirelessly communicate with the visor, for example, by means of Bluetooth or similar wireless communication protocol, in which case, the processor need not be mounted on the headset but can instead be located remotely from the headset, with the relative allowable distance between them being dictated and limited only by the wireless communication protocol being employed. For example, the processor could be mounted on, or formed integrally with, the user's clothing, or instead located remotely from the user, either as a stand-alone unit or as an integral part of a larger control unit, for example.

Referring to FIG. 2 of the drawings, a system according to an exemplary embodiment of the invention comprises, generally, a headset 100, incorporating a screen 102, a processor 104, and a pair of external digital image capture devices (only one shown) 106.

Referring additionally to FIG. 3 of the drawings, the processor 104 generates, and displays on the screen within the headset, a three dimensional virtual environment which includes interactive virtual displays 30 and controls with which, say, the pilot of an aircraft can interact. Digital video image frames of the user's real world environment are captured by the image capture devices provided on the headset, and two image capture devices are used in this exemplary embodiment of the invention to capture respective images such that the data representative thereof can be blended to produce a stereoscopic depth map which enables the processor to determine depth within the captured images without any additional infrastructure being required. The vehicle's external environment 50, as well as selected physical control elements 70, 80 and the basic control environment (e.g. cockpit) structure 20 are rendered from the captured images and blended into the three-dimensional virtual environment displayed on the screen to create a complete, mixed reality vehicle control environment. The controls 70, 80 selected to be provided in their physical, rather than virtual, form may be preconfigured for a particular application and comprise, for example, safety critical controls. However, the present invention extends to the case whereby a user can select, according to their own preference, which controls should be provided and displayed in their physical form and which are provided as interactive virtual displays. Either way, the user is provided with expected visual cues, such as their own body 40, within the three dimensional virtual environment, again by rendering and blending images data representative thereof, from the captured images, into the virtual environment displayed on the screen.

Since the user's entire field of view is thus selectively modified by the processor 104, it is also possible to provide symbology 60 which appears external to the aircraft, such as caption boxes on other aircraft or free floating information representing a specific context, thereby providing a more intuitive user interface whilst reducing the potential opportunity for human error.

The processor 104 receives data from multiple sources in and on the vehicle in relation to the parameters and characteristics to which the virtual controls relates, and updates the representations thereof in real time in accordance with the data thus received.

The concept of real time image blending for augmented reality is known, and several different techniques have been proposed. The present invention is not necessarily intended to be in any way limited in this regard. However, for completeness, one exemplary method for image blending will be briefly described. Thus, in respect of an object or portion of a real world image to be blended into the virtual environment, a threshold function may be applied in order to extract that object from the background image. Its relative location and orientation may also be extracted and preserved by means of marker data. Next, the image and marker data is converted to a binary image, possibly by means of adaptive thresholding (although other methods are known). The marker data and binary image are then transformed into a set of coordinates which match the location within the virtual environment in which they will be blended. Such blending is usually performed using black and white image data. Thus, if necessary, colour data sampled from the source image can be backward warped, using homography, to each pixel in the resultant virtual scene. All of these computational steps require minimal processing and time and can, therefore, be performed quickly and in real (or near real) time. Thus, as the vehicle moves and the external scenery changes and the vehicle status changes, for example, image data within the mixed reality environment can be updated in real time.

Interaction with the virtual control elements within the three dimensional virtual environment can be effected by, for example, hand gestures made by the user. Several different techniques for automated recognition of hand gestures are known, and the present invention is not in any way intended to be limited in this regard. For example, predefined hand gestures may be provided that are associated with specific actions, in which case, the processor is preconfigured to recognise those specific predefined hand gestures (and/or hand gestures made at a particular location ‘relative’ to the interactive virtual controls) and cause the associated action to be performed in respect of a selected object, control, application or data item. Alternatively, a passive control panel or keyboard may be provided that appears to “operate” like a normal control panel or keyboard, except the user's actions in respect thereof are captured by the image capture devices, and the processor is configured to employ image recognition techniques to determine which keys, control elements or icons the user has pressed, or otherwise interacted with, on the control panel or keyboard, and cause the required action to be performed in respect of the selected object, control, application or data item. In yet another exemplary embodiment of the invention, the three-dimensional virtual environment may include images of conventional control elements, such as buttons, switches or dials, for example, with which the user can interact in and apparently conventional manner by means of appropriate hand gestures and actions captured by the image capture devices, and the processor is configured to recognise such hand gestures/actions and generate the appropriate control signals accordingly.

In any event, it will be appreciated that the image capture devices provided in the system described above can be used to capture video images of the user's hands (which can be selected to be blended into the 3D virtual environment displayed on the user's screen). Thus, one relatively simple method of automated hand gesture recognition and control using captured digital video images involves the use of a database of images of predefined hand gestures and the command to which they relate, or indeed, a database of images of predefined hand locations (in relation to the keyboard, control panel or virtual switches/buttons/dials) and/or predefined hand configurations, and the action or control element to which they relate. Thus, an auto threshold function is first performed on the image to extract the hand from the background. The wrist is then removed from the hand shape, using a so-called “blob” image superposed over the palm of the hand, to separate out the individual parts of the hand so that the edge of the blob defines the border of the image. The parts outside of the border (i.e. the wrist) are then removed from the image, following which shape recognition software can be used to extract and match the shape of a hand to a predefined hand gesture, or “markers associated with the configuration of the control panel or keyboard, or even physical location and/or orientation sensors such as accelerometers and the like, can be used to determine the relative position and hand action, and call the associated command accordingly.

It will be appreciated that the resultant vehicle control environment can be relatively easily configured and reconfigured, if required, without the need for significant costly hardware changes. Although it is possible, in theory, to configure all of the functionality of a particular vehicle control environment, in some applications, there may be critical functions which, for safety or purely due to user preference and comfort, should remain in their real world configuration. In this case, the processor may be configured to identify, within the captured images, the location within the physically proportioned control environment structure 20 of that function (e.g. the stick and throttle 70 and a control panel 80 within an aircraft cockpit environment), and automatically blend and retain an image thereof within the user's three dimensional virtual environment, such that the user can see its location and can physically interact with it, as required.

It will be appreciated by a person skilled in the art, from the foregoing description, that modifications and variations can be made to the described embodiments without departing from the scope of the present invention as claimed.

What is claimed is:

1. A mixed reality vehicle control system for enabling monitoring and/or control within a vehicle of functions and/or operations thereof by a user, the system comprising:
a headset including a screen, the system further comprising:
a processor configured to receive data from one or more sources within said vehicle and display images representing virtual control elements in respect of said vehicle, together with said data, within a three dimensional virtual environment on said screen;
wherein the system is configured to allow said user, in use, to interact with and/or manipulate said virtual control elements;
the processor being further configured, in response to such user interaction or manipulation, transmit control data to respective vehicle functions or operations for control thereof;
the system further comprising an image capture device for capturing images of the real world environment in the vicinity of the user within the user's field of view, including image data representative of physical control elements therein, and blend image data representative of at least portions of said user's field of view, including at least one of said physical control elements, into said three dimensional virtual environment to create a mixed reality vehicle control environment.

2. (canceled)

3. The system according to claim 1, wherein said processor is preconfigured to identify within said captured images at least one predefined physical control element in the real world within said vehicle, and blend image data representative thereof into said three dimensional virtual environment.

4. The system according to claim 1, configured to allow the user, in use, to manipulate data and/or interact with said virtual control elements by means of hand gestures.

5. The system according to claim 4, further comprising a physical control panel including one or more physical control devices which are manually actuatable by a user, wherein said processor is configured to identify, within said captured images, user hand gestures indicative of actuation of said one or more physical control devices and generate a respective control signal for controlling a function and/or operation of said vehicle.

6. The system according to claim 1, comprising a pair of spatially separated image capture devices for capturing respective images of the real world environment in the user's field of view, said processor being configured to define a depth map using respective image frame pairs to produce three dimensional image data.

7. The system according to claim 6, wherein said image capture devices are mounted on said headset.

8. The system according to claim 7, wherein said image capture devices are mounted on said headset so as to be substantially aligned with a user's eyes, in use.

9. The system according to claim 1, wherein the processor is configured to generate information symbols or messages in relation to real world objects identified within said captured images, and blend image data representative thereof into said three dimensional virtual environment at an associated location therein.

10. A method of providing a vehicle control station enabling monitoring and/or control within a vehicle of functions and/or operations thereof, the method comprising:
providing a mixed reality system according to claim 1, and configuring the processor to
receive data from one or more sources within said vehicle and display images representing virtual control elements in respect of said vehicle, together with said data, within a three dimensional virtual environment on said screen, wherein the system is configured to allow said user, in use, to interact with and/or manipulate said virtual control elements;
in response to such user interaction or manipulation, transmit control data to respective vehicle functions or operations for control thereof, the system further comprising an image capture device for capturing images of the real world environment in the vicinity of the user within the user's field of view, including image data representative of physical control elements therein; and
blend image data representative of at least portions of said user's field of view, including at least one of said physical control elements, into said three dimensional virtual environment to create a mixed reality vehicle control environment.

11. (canceled)

12. The method according to claim 10, wherein the vehicle control station is an aircraft cockpit comprising a plurality of control elements.

13. The method according to claim 12, including the steps of providing a vehicle cab or cockpit structure including only a selected number of said control elements as physical control elements, providing the remaining control elements as virtual control elements within said three dimensional virtual environment, and configuring the processor to blend image data representative of a user's field of view, from said captured images, into said three dimensional virtual environment to create a mixed reality environment.
